(19) United States
(12) Patent Application Publication
(10) Pub. No.: US 2025/0233639 A1
(43) Pub. Date: Jul. 17, 2025

(54) COMMUNICATION CONTROL APPARATUS, COMMUNICATION SYSTEM, STORAGE MEDIUM, AND COMMUNICATION CONTROL METHOD

(71) Applicant: NEC Corporation, Tokyo (JP)

(72) Inventors: Kohei Yoshida, Tokyo (JP); Junichi Funada, Tokyo (JP); Masayuki Ariyoshi, Tokyo (JP)

(73) Assignee: NEC Corporation, Tokyo (JP)

(21) Appl. No.: 18/985,207

(22) Filed: Dec. 18, 2024

(30) Foreign Application Priority Data
Dec. 27, 2023 (JP) 2023-221140

(51) Int. Cl. H04B 7/06; H04L 5/00

(52) U.S. Cl. CPC H04B 7/06952; H04L 5/0098

(57) ABSTRACT

In order to achieve an object that is to provide a communication control apparatus capable of improving utilization efficiency of frequency bands in communication using beams, the communication control apparatus includes at least one processor, which carries out: a control process of controlling a communication apparatus capable of communicating with a plurality of communication terminals by irradiating the plurality of communication terminals with a radio wave beam from an antenna; an acquisition process of acquiring control information that includes terminal position information indicating positions of the plurality of communication terminals, apparatus position information indicating a position of the communication apparatus, and constraint information including information indicating a physical constraint of the antenna; and a determination process of determining, on the basis of the control information, a directivity pattern of the antenna in generation of the beam, and allocation of a frequency band to the beam.

This application is based upon and claims the benefit of priority from Japanese patent application No. Tokugan 2023-221140, filed on Dec. 27, 2023, the disclosure of which is incorporated herein in its entirety by reference.

### TECHNICAL FIELD

The present disclosure relates to a communication control apparatus, a communication system, a storage medium, and a communication control method.

### BACKGROUND ART

A known technology allocates different frequency bands to respective beams so as to prevent radio wave interference between beams from occurring in communication using a plurality of radio wave beams. Examples of a technology for allocating frequency bands include, for example, a wireless communication system disclosed in Patent Literature 1. This wireless communication system includes an information notification means and a parameter control means. The information notification means acquires wireless environment information and notifies a central control station of the wireless environment information together with base station apparatus information. The parameter control means controls, with use of parameters which are set by the central control station, an antenna pattern, a transmission power value, a CCA threshold, an RS threshold, a channel, and a bandwidth. In this wireless communication system, the central control station includes a parameter calculation and control means. The parameter calculation and control means calculates a first parameter, a second parameter, and a third parameter on the basis of the wireless environment information and the base station apparatus information which the central control station is notified of by a plurality of wireless base stations, and sets those parameters for the plurality of wireless base stations. The first parameter is for controlling a communication area by an antenna pattern. The second parameter is for controlling the communication area with use of at least one selected from the group consisting of the transmission power value, the CCA threshold, and the RS threshold. The third parameter is for setting the channel and the bandwidth.

### CITATION LIST

### Patent Literature

### [Patent Literature 1]

Japanese Patent Application Publication Tokukai No. 2017-103553

### SUMMARY OF INVENTION

### Technical Problem

In performing irradiation with a plurality of beams, the communication apparatus may also irradiate, with a beam, a place where density of communication apparatuses is low, a place where a certain communication terminal is absent, or the like, and form a cell in such a place or the like. In this case, the wireless communication system disclosed in Patent Literature 1 allocates, to the beam that forms the cell whose utilization rate is low, a frequency band which is different from other frequency bands allocated to beams for forming other cells. This results in infrequent utilization of the frequency band deliberately allocated, and causes a problem from the viewpoint of efficiency. Further, the problem applies to communication with use of an artificial satellite. In particular, in recent years, the number of low earth orbit (LEO) satellites which travel in low earth orbits is remarkably increasing, and the LEO satellites are under a situation in which critical shortage of frequency bands in Ku band and Ka band are occurring.

The present disclosure is accomplished in view of the above problem, and an example object of the present disclosure is to provide a technology for improving utilization efficiency of frequency bands in communication using beams.

### Solution to Problem

A communication control apparatus in accordance with an example aspect of the present disclosure includes at least one processor, the at least one processor carrying out: a control process of controlling a communication apparatus capable of communicating with a plurality of communication terminals by irradiating the plurality of communication terminals with a radio wave beam from an antenna; an acquisition process of acquiring control information that includes terminal position information indicating positions of the plurality of communication terminals, apparatus position information indicating a position of the communication apparatus, and constraint information including information indicating a physical constraint of the antenna; and a determination process of determining, on the basis of the control information, a directivity pattern of the antenna in generation of the beam, and allocation of a frequency band to the beam.

A communication system in accordance with an example aspect of the present disclosure includes: a plurality of communication terminals; an artificial satellite that travels in an orbit and that is a communication apparatus which communicates with the plurality of communication terminals; and the communication control apparatus described above.

A storage medium in accordance with an example aspect of the present disclosure is a non-transitory storage medium storing therein a communication control program for causing at least one processor to carry out: a control process of controlling a communication apparatus capable of communicating with a plurality of communication terminals by irradiating the plurality of communication terminals with a radio wave beam from an antenna; an acquisition process of acquiring control information that includes terminal position information indicating positions of the plurality of communication terminals, apparatus position information indicating a position of the communication apparatus, and constraint information including information indicating a physical constraint of the antenna; and a determination process of determining, on the basis of the control information, a directivity pattern of the antenna in generation of the beam, and allocation of a frequency band to the beam.

A communication control method in accordance with an example aspect of the present disclosure is a communication control method for controlling a communication apparatus, the communication apparatus being capable of communicating with a plurality of communication terminals by irradiating the plurality of communication terminals with a radio wave beam from an antenna, the communication control method including: an acquisition process in which at least one processor acquires control information that includes terminal position information indicating positions of the plurality of communication terminals, apparatus position information indicating a position of the communication apparatus, and constraint information including information indicating a physical constraint of the antenna; and determination process in which the at least one processor determines, on the basis of the control information, directivity pattern of the antenna in generation of the beam, and allocation of a frequency band to the beam.

### Advantageous Effects of Invention

An example aspect of the present disclosure yields an example advantage of making it possible to provide a technology for improving utilization efficiency of frequency bands in communication using beams.

### BRIEF DESCRIPTION OF DRAWINGS

FIG. 1 is a diagram illustrating an examples of a schematic configuration of a communication control apparatus in accordance with the present disclosure.

FIG. 2 is a flowchart illustrating an example flow of a communication control method in accordance with the present disclosure.

FIG. 3 is a diagram illustrating an example of an antenna of a communication apparatus which is to be controlled by the communication control apparatus in accordance with the present disclosure.

FIG. 4 is a diagram illustrating an example of a circuit configuration of the antenna in accordance with the present disclosure.

FIG. 5 is a diagram illustrating a radio wave beam(s) with which the antenna in accordance with the present disclosure performs irradiation.

FIG. 6 is a block diagram illustrating another example of a functional configuration of the communication control apparatus in accordance with the present disclosure.

FIG. 7 is a diagram illustrating frequency band allocation that is carried out by the communication control apparatus in accordance with the present disclosure.

FIG. 8 is a diagram illustrating a beam(s) with which an antenna of a communication apparatus performs irradiation by control of the communication control apparatus in accordance with the present disclosure.

FIG. 9 is a flowchart illustrating an example flow of clustering that is carried out by the communication control apparatus in accordance with the present disclosure.

FIG. 10 is a diagram illustrating how beam shapes are determined, on the basis of an optimization index, by the communication control apparatus in accordance with the present disclosure.

FIG. 11 is a diagram illustrating correction of a cluster that is carried out by the communication control apparatus in accordance with the present disclosure.

FIG. 12 is a block diagram illustrating another example of a functional configuration of the communication control apparatus in accordance with the present disclosure.

FIG. 13 is a diagram illustrating an example of a configuration of a communication system in accordance with the present disclosure.

FIG. 14 is a flowchart illustrating an example flow of a communication control method in accordance with the present disclosure.

FIG. 15 is a flowchart illustrating another example flow of the communication control method in accordance with the present disclosure.

FIG. 16 is a block diagram illustrating a hardware configuration of a computer which functions as the communication control apparatus in accordance with the present disclosure.

### DESCRIPTION OF EMBODIMENTS

The following description will discuss an example embodiment of the present invention. Note, however, that the present invention is not limited to example embodiments discussed below, but may be altered in various ways by a skilled person within the scope of the claims. For example, the present invention can also encompass, in its scope, any example embodiment derived by appropriately combining technical means employed in the example embodiments discussed below. The present invention can also encompass, in its scope, any example embodiment derived by appropriately omitting part of technical means employed in the example embodiments described below. An example advantage mentioned in each of the example embodiments below is an example of an advantage that is expected in that example embodiment, and is not intended to delimit the present invention. That is, the present invention can also encompass, in its scope, any example embodiment that does not yield the example advantages discussed in the example embodiments below.

### First Example Embodiment

The following description will discuss a first example embodiment, which is an example embodiment of the present invention, in detail with reference to the drawings. The present example embodiment is an embodiment serving as a basis for example embodiments described later. It should be noted that the applicable scope of each technical means employed in the present example embodiment is not limited to the present example embodiment. That is, each technical means employed in the present example embodiment can be employed also in another example embodiment included in the present disclosure, provided that no particular technical problems occur. Further, each technical means illustrated in the drawings which are referred to for describing the present example embodiment can be employed in another example embodiment included in the present disclosure, provided that no particular technical problems occur.

### (Configuration of Communication Control Apparatus)

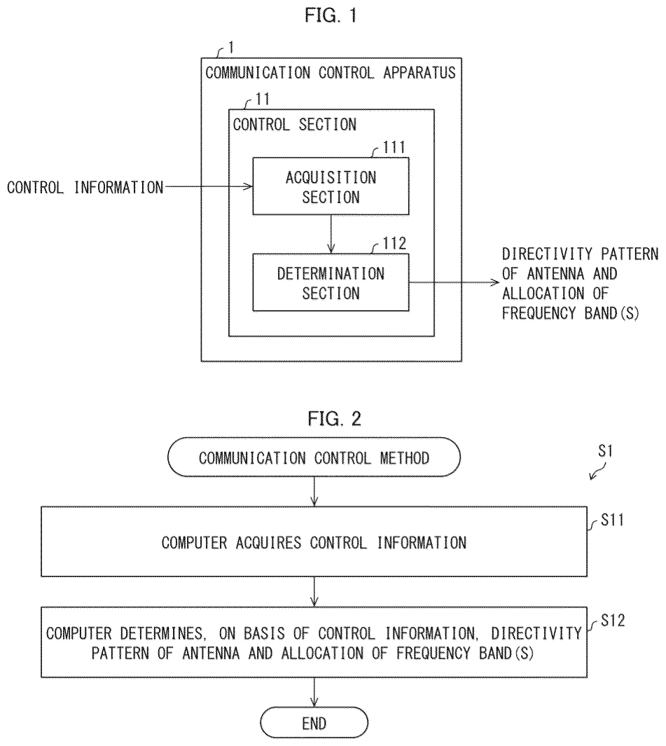

The following will describe a configuration of a communication control apparatus 1, with reference to FIG. 1. FIG. 1 is a block diagram illustrating the configuration of the communication control apparatus 1. The communication control apparatus 1 includes a control section 11, as illustrated in FIG. 1. Further, the control section 11 includes an acquisition section 111 and a determination section 112. The control section 11 controls the communication apparatus 2. Examples of the communication apparatus 2 include artificial satellites, wireless base stations installed on the ground, and aircrafts (e.g., spacecrafts) each constituting a high altitude platform station (HAPS), etc.

### Acquisition Section

The acquisition section 111 acquires control information. The control information includes terminal position information, apparatus position information, and constraint information.

The terminal position information indicates respective positions of a plurality of communication terminals 3. The communication terminals 3 are each an apparatus that communicates with the communication apparatus 2. Examples of the communication terminals 3 include ground base stations, mobile base stations, general communication terminals (e.g., smartphones, tablets, etc.), and the like. The acquisition section 111 may acquire the terminal position information, by intersatellite communication, from another artificial satellite that travels in the same orbit as the communication apparatus 2, or may acquire in advance from ground equipment (ground base station). Alternatively, the acquisition unit 111 may acquire the terminal position information which the communication apparatus 2 itself obtained by scanning the ground. Alternatively, in a case where the communication terminals 3 are movable, the acquisition section 111 may predict, on the basis of current movement speeds of the communication terminals 3, the positions of the communication terminals 3 for the time at which irradiation with a beam(s) B is performed, and may acquire, as the terminal position information, values thus predicted.

The apparatus position information indicates a position of the communication apparatus 2. The acquisition section 111 may acquire, for example, the apparatus position information which the communication apparatus 2 itself calculated on the basis of a beacon that had been received from the ground equipment.

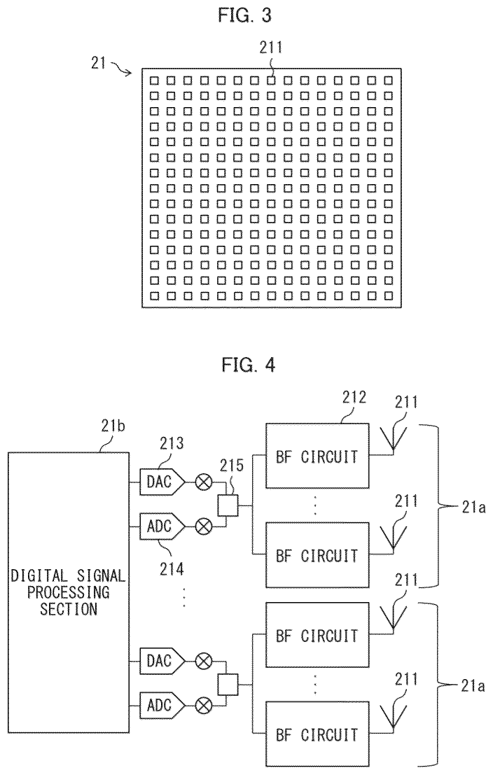

The constraint information includes antenna information. The communication apparatus 2 includes an antenna 21 (see FIG. 3). Thus, the communication apparatus 2 can communicate with the plurality of communication terminals 3 by irradiating the plurality of communication terminals 3 with radio wave beams B from the antenna 21. The antenna information indicates a physical constraint (specifies the number or shape of subarrays that can be formed) of the antenna 21 provided in such a communication apparatus 2. Specifically, the constraint information includes information on an array (N rows by M columns) of antenna elements 211, an array (n rows by m columns) of unit configurations 21a . . . , and the like.

### Determination Section

The determination section 112 determines, on the basis of the control information acquired by the acquisition section 111, a directivity pattern of the antenna 21 in generation of the beams B and allocation of frequency bands to the beams B. The “directivity pattern” includes the number of beams B, respective shapes of the beams B, respective irradiation angles of the beams B, and gain of the antenna 21. The “number of beams B” is determined in accordance with the number of subarrays (equal to the number of the subarrays). The “shapes of the beams B (cross-sectional shapes in a case where the beams B are cut along a plane orthogonal to an irradiation direction)” are determined by respective shapes of the subarrays. In other words, in a case where the shape of a subarray is square, the shape of a corresponding beam B is circular. On the other hand, in a case where the shape of a subarray is rectangular, the shape of a corresponding beam B is elliptical. The “gain of the antenna 21” is correlated with width of the beams B, and determined in accordance with respective sizes of the subarrays. In other words, the larger a subarray is, the narrower the width of a beam B becomes and the higher the gain becomes. On the other hand, the smaller a subarray is, the larger the width of a beam B becomes and the lower the gain becomes.

### (Example Advantage of Communication Control Apparatus)

The communication control apparatus 1 described above is configured to allocate frequency bands to respective beams B on the basis of control information that includes terminal position information, apparatus position information, and constraint information. That is, the frequency bands allocated to the respective beams B correspond to the number, distribution, and/or the like of the communication terminals 3. Therefore, the communication control apparatus 1 in accordance with the present example embodiment can yield an example advantage of making it possible to improve utilization efficiency of frequency bands in communication using the beams B.

### (Flow of Communication Control Method)

The following description will discuss a flow of a communication control method S1, with reference to FIG. 2. FIG. 2 is a flowchart illustrating the flow of the communication control method S1. The communication control method S1 controls the communication apparatus 2. As illustrated in FIG. 2, the communication control method S1 includes an acquisition process S11 and a determination process S12.

### Acquisition Process

In a first acquisition process S11, a computer acquires control information. The computer may constitute the communication control apparatus 1, 1A, 1B, or 1C. Alternatively, the computer may be mounted on each communication apparatus 2 or may be mounted on ground equipment (CU etc.). The computer acquires the control information from the communication apparatus 2 (which is communicating with a communication terminal 3) which is irradiating the communication terminal 3 with a beam B. The control information includes terminal position information, apparatus position information, and constraint information, similarly to that acquired by the communication control apparatuses 1, 1A, 1B, and 1C.

### Determination Process

After the control information is acquired, the process proceeds to a determination process S12. In the determination process S12, the computer determines, on the basis of the control information, the number of beams of the antenna 21 in generation of the beams B, beam shapes, antenna gain, beam angles, and allocation of the frequency bands to the beams B. In a case where the number of beams is two or more, respective beam shapes, antenna gain, respective beam angles, allocation of respective frequency bands to the beams B are determined for the two or more beams B. In the case where the number of beams is two or more, it is possible to use a method that is similar to a method carried out by the communication control apparatus 1, for determining, for the two or more beams B which are to be generated, respective shapes, respective directivity patterns and allocation of respective frequency bands.

### (Example Advantage of Communication Control Method)

As described above, the communication control method S1 is configured to allocate frequency bands to respective beams B on the basis of control information which includes terminal position information, apparatus position information, and constraint information. That is, the frequency bands allocated to the respective beams B correspond to the number, distribution, and/or the like of the communication terminals 3. Therefore, the communication control method S1 can yield an example advantage of making it possible to improve utilization efficiency of the frequency bands in communication using the beams B.

### Second Example Embodiment

The following description will discuss a second example embodiment, which is an example embodiment of the present invention, in detail with reference to the drawings. Members having functions identical to those of the respective members discussed in the foregoing example embodiment are given respective identical reference numerals, and the description of those members is omitted as appropriate. It should be noted that the applicable scope of each technical means employed in the present example embodiment is not limited to the present example embodiment. That is, each technical means employed in the present example embodiment can be employed also in another example embodiment included in the present disclosure, provided that no particular technical problems occur. Further, each technical means illustrated in the drawings which are referred to for describing the present example embodiment can be employed in another example embodiment included in the present disclosure, provided that no particular technical problems occur.

### (Configuration of Antenna of Communication Apparatus Controlled by Communication Control Apparatus)

Before describing a communication control apparatus 1A in accordance with the present example embodiment, the following description will discuss a configuration of an antenna 21 included in a communication apparatus 2 which is to be controlled by the communication control apparatus 1A, with reference to FIGS. 3 and 4. FIG. 3 is a diagram illustrating the antenna 21. FIG. 4 is a diagram illustrating a circuit configuration of the antenna.

The antenna 21 in accordance with the present example embodiment is a phased array antenna. That is, the antenna 21 can direct a radio wave beam B into a desired direction by adjustment of phases of radio waves emitted by a plurality of antenna elements. Specifically, the antenna 21 has, for example, a configuration in which a plurality of antenna elements 211 are arranged in a matrix shape, as illustrated in FIG. 3. The antenna 21 in accordance with the present example embodiment has a configuration in which the antenna elements 211 are arranged in an array of 15 rows by 15 columns, but the antenna 21 is not limited to such a configuration. That is, the antenna 21 may have fewer or more antenna elements 211 than that illustrated in FIG. 3. Further, the antenna 21 may have an array in which the number of rows and the number of columns of the antenna elements 211 are different from each other.

Moreover, the antenna 21 carries out beamforming (BF) in a hybrid mode. Specifically, for example, as illustrated in FIG. 4, the antenna 21 has a circuit configuration in which a plurality of unit configurations 21a for carrying out BF in an analog mode are connected to a single digital signal processing section 21b (DSP). The unit configurations 21a each include a predetermined number of antenna elements 211, BF circuits 212, a DA converter 213, an AD converter 214, and a dividing/coupling circuit 215. The BF circuits 212 each is connected to an antenna element 211, and adjusts a phase and an amplitude of a radio wave which is emitted by the antenna element 211. The dividing/coupling circuit 215 combines analog signals from the BF circuits 212, and sends a combined signal to the AD converter 214. The dividing/coupling circuit 215 also distributes an analog signal from the DA converter 213 to each of the BF circuits 212. Note that the antenna 21 may be configured to carry out BF in a digital mode in which for each of the antenna elements, AD/DA conversion of a signal that is received or to be transmitted in that individual antenna element is carried out.

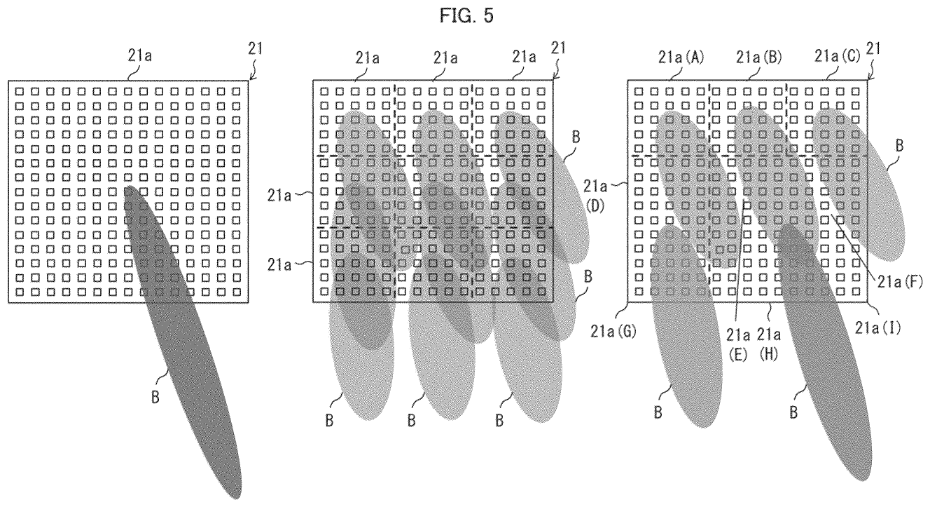

The antenna 21 can form one or more subarrays. The subarrays are each composed of one or more unit configurations 21a. The predetermined number of antenna elements 211 included in each of the unit configurations 21a are arranged in a matrix as illustrated in FIG. 5. The unit configuration 21a in accordance with the present example embodiment is configured such that the antenna elements 211 are arranged in an array of 5 rows by 5 columns, but the unit configuration 21a is not limited to such a configuration. That is, the unit configuration 21a may have fewer or more antenna elements 211 than that illustrated in FIG. 5. Further, the unit configuration 21a may have an array in which the number of rows and the number of columns of the antenna elements 211 are different from those illustrated in FIG. 5. Furthermore, the unit configurations 21a are also arranged in a matrix shape, as illustrated in FIG. 5. The antenna 21 in accordance with the present example embodiment is configured such that the unit configurations 21a are arranged in an array of 3 rows by 3 columns, but the antenna 21 is not limited to such a configuration. That is, the antenna 21 may have fewer or more unit configurations 21a than that illustrated in FIG. 5. Further, the antenna 21 may be have an array in which the number of rows and the number of columns of the unit configurations 21a are different from each other. In the antenna 21, one or more subarrays are formed by using such a unit configuration 21a independently or combining a plurality of such unit configurations 21a. Hereinafter, the number of subarrays in the antenna 21 and respective sizes and respective shapes of the subarrays are collectively referred to as a “subarray configuration”. The antenna 21 emits one beam B from one subarray. That is, the number of subarrays formed in the antenna 21 becomes the number of beams B with which the antenna 21 performs irradiation. Further, the antenna 21 emits, from a subarray, a beam B in an aspect (width and shape) corresponding to the size and shape of that subarray.

In the antenna 21 in accordance with the present example embodiment, in a case where all of the unit configurations 21a (nine in the case of the antenna 21 in FIG. 5) are combined, one subarray is formed in the antenna 21, for example, as illustrated in the left part of FIG. 5. In the case of such a subarray configuration, the antenna 21 performs irradiation with a single beam B. The smaller the number of beams B generated becomes, the narrower the width of the beams B becomes and the higher the gain becomes. Further, in the case of this subarray configuration, since the subarray is square, the antenna 21 performs irradiation with a beam B whose cross section is circular in a case where the beam B is cut along a plane orthogonal to an irradiation direction.

In a case where each of the unit configurations 21a is used independently in the antenna 21 in accordance with the present example embodiment, nine subarrays are formed in the antenna 21, for example, as illustrated in a central part of FIG. 5. In the case of this subarray configuration, the antenna 21 performs irradiation with nine beams B. The larger the number of beams B generated becomes, the larger the width of the beams B becomes and the lower the gain becomes. Further, also in the case of this subarray configuration, since each of the subarrays is square, the antenna 21 performs irradiation with the beams B whose cross sections are circular in a case where the beams B are cut along a plane orthogonal to an irradiation direction.

In the antenna 21 in accordance with the present example embodiment, in a case where one or some of the unit configurations are each used independently and remaining unit configurations are combined, the number of subarrays formed in the antenna 21 corresponds to how the unit configurations 21a are combined. A right part of FIG. 5 illustrates, as an example, a case including the following subarrays: respective subarrays using three unit configurations 21a (A, B, and C) of the first row independently; a subarray in which two unit configurations 21a (D and G) of second and third rows below the first row are combined; and a subarray in which remaining four unit configurations 21a (E, F, H, and I) are combined. However, the subarray configuration is not limited to this configuration. In the case of the subarray configuration illustrated in the right part of FIG. 5, the antenna 21 performs irradiation with five beams B. The beam B generated from the subarray consisting of the two unit configurations 21a has a narrower width than the beam B generated from the subarray consisting of one unit configuration 21a, and the gain becomes higher. Further, the beam B generated from the subarray consisting of the four unit configurations 21a has a narrower width than the beam B generated from the subarray consisting of the two unit configurations 21a, and the gain becomes higher. In the case of this subarray configuration, since the subarray consisting of the two unit configurations 21a has a vertically long rectangular shape, the antenna 21 performs irradiation with a beam B whose cross section has a laterally long elliptical shape in a case where the beam B is cut along a plane orthogonal to the irradiation direction. This is because as more antenna elements 211 are lined up, the beam B generated by the antenna 21 becomes sharper in a direction in which the antenna elements 211 are aligned (in other words, the width of the beam B becomes narrower in that direction). Note that, in a case where a subarrays has a laterally long rectangular shape, the antenna 21 performs irradiation with a beam B whose cross section is a vertically long elliptical shape. Description up to here dealt with the communication apparatus and the antenna.

### (Configuration of Communication Control Apparatus)

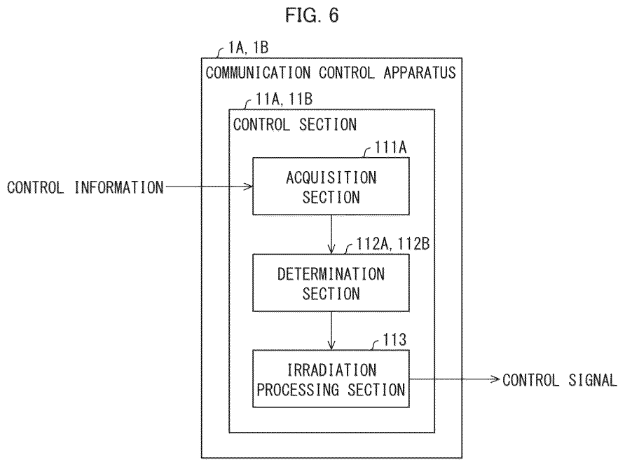

The following description will discuss a configuration of an communication control apparatus 1A, with reference to FIG. 6. FIG. 6 is a block diagram illustrating the configuration of the communication control apparatus 1A. The communication control apparatus 1A includes a control section 11A. The control section 11A includes an acquisition section 111A, a determination section 112A, and an irradiation processing section 113.

### Acquisition Section

Control information acquired by the acquisition section 111A in accordance with the present example embodiment includes terminal position information, apparatus position information, and constraint information which are acquired by the acquisition section 111 in accordance with the first example embodiment. The control information further includes at least one selected from the group consisting of a requested traffic amount, an application of communication, a maximum number of beams, power consumption, and requested service quality (quality of service: QoS).

The term “requested traffic amount” refers to an amount of data which is desired to be transmitted to/received from the communication terminal 3.

The term “maximum number of beams” refers to an upper limit of the number of beams B that can be generated. In a case where the control information includes the maximum number of beams and/or the power consumption, the acquisition section 111 acquires a remaining power. The remaining power is a remaining amount of electric power which a battery provided in the communication apparatus 2 can supply. Upon acquisition of the remaining power, the acquisition section 111 calculates the maximum number of beams on the basis of the remaining power.

The term “power consumption” is electric power required to generate the beams B. The acquisition section 111 may calculate a transmission power on the basis of the remaining power and the power consumption, upon acquisition of the remaining power.

### Determination Section

In determining a directivity pattern of the antenna 21 on the basis of the control information, the determination section 112A in accordance with the present example embodiment calculates the width of a beam and the gain of an antenna, for example, as follows. The determination section 112A first calculates ok, which is a weight of a phase to be added to the k-th antenna element, with use of a steering vector. Next, the determination section 112A calculates an array factor D(θ) with use of Formula (1) below. In the Formula (1), Ak is the weight of an amplitude applied to the k-th antenna element.

$$D ( θ ) = {\sum }_{k = 1}^{K} {A}_{k} exp \{ j ( - \frac{2 π}{λ} {d}_{k} sin θ + {δ}_{k} ) \} \qquad ( 1 )$$

Next, the determination section 112A calculates a total ESUM of respective outputs of the antenna elements 211 with use of Formula (2) below. In the Formula (2), E0 is reception power of an arrived signal at a reference point, and g(θ) is a directivity function of a single antenna element. The absolute value of the total ESUM calculated here is a value indicating the width of the beam and the gain of the antenna.

$${E}_{sum} = {E}_{o} g ( θ ) D ( θ ) \qquad ( 2 )$$

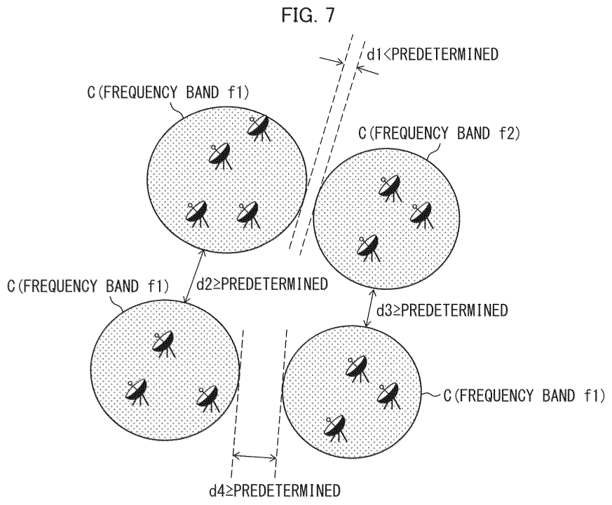

Further, the determination section 112A in accordance with the present example embodiment determines allocation of frequency bands to respective beams B on the basis of a positional relation of a plurality of cells C which are to be formed by the beams B with which irradiation in a directivity pattern is performed. The term “positional relation of cells C” includes information such as a distance between the cells C, whether or not the cells partially overlap with each other, and the like. Specifically, the determination section 112A allocates different frequency bands f1 and f2 to respective beams B in the following cases. The case in which the different frequency bands f1 and f2 are allocated include, for example, a case in which a distance d1 between two cells C is less than a predetermined distance or a case where part of one cell C overlaps with another cell C, as illustrated in FIG. 7. In such a case, the beams B that form the plurality of cells C cause radio wave interference, and thus, the different frequency bands f1 and f2 are allocated. On the other hand, in the following cases, the same frequency band f1 is allocated to all of beams B. The cases in which the same frequency band f1 is allocated include a case where distances d2, d3, and d4 between two cells C are equal to or greater than a predetermined distance. In this case, the beams B that form the plurality of cells C do not cause radio wave interference, and thus, the same frequency f1 is allocated. The determination section 112A in accordance with the present example embodiment selects and allocates a frequency band(s) from among a plurality of frequency bands that are different from each other and that are included in frequency information. By carrying out such allocation, the number of frequency bands to be utilized can be minimized, so that utilization efficiency of the frequency bands is improved. Note that the determination section 112A may be configured to allocate, to a beam(s) B, for example, a frequency band which is higher or lower by a predetermined number than a frequency of a default frequency band, without using the frequency information.

Moreover, the determination section 112A calculates an optimization index for each combination of the directivity pattern of the antenna 21 and the allocation of a frequency band(s). The “optimization index” may include a system rate and/or service quality (quality of service: QoS). The “system rate” is a total of respective communication path capacities which a plurality of communication terminals 3 are in need of. The term “service quality” is quality of communication in accordance with an application of communication that is carried out by each of the plurality of communication terminals 3. In a case where the optimization index is, for example, the system rate, the determination section 112A calculates the optimization index, for example, in the following manner. The determination section 112A first calculates a signal to interference plus noise ratio (SINR) of each of the communication terminals 3 with use of Formula (3) below. In the Formula (3), P is reception power, Ii is interference power, and NO is noise power.

$$SIN R = \frac{P}{{\sum }_{i = 1}^{N} {I}_{i} + {N}_{0}} \qquad ( 3 )$$

Next, the determination section 112A calculates the communication path capacity C of each communication terminal by substituting, into Formula (4) below, the SINR (S/N) calculated. B in the Formula (4) is bandwidth. Then, the determination section 112A calculates the system rate by summing respective communication path capacities C which have been acquired for the communication terminals 3.

$$C = B {log}_{2} ( 1 + \frac{S}{N} ) \qquad ( 4 )$$

After the optimization index is calculated for each of all combinations of the directivity pattern and the allocation of the frequency band(s), the determination section 112A selects, from among all the combinations, a combination with which the optimization index is most improved. Then, the determination section 112A determines the combination thus selected, as the directivity pattern and the allocation of the frequency band(s) for the time at which the antenna 21 performs irradiation with the beam(s) B. In a case where the optimization index is the system rate, the determination section 112A selects a combination with which a value of the system rate becomes highest. In a case where the optimization index is the service quality (i.e., a case in which the control information includes the requested service quality), the determination section 112A selects a combination of a directivity pattern and allocation of a frequency band(s) which can satisfy the requested service quality defined by the control information. Note that in cases below, the determination section 112A may allocate resources in order from communication with a higher degree of priority, with reference to a degree of priority that is associated with each communication and that is determined by requested service quality of each communication which is defined by the control information. Cases in which resources are allocated in order from communication with a higher degree of priority include, for example, a case where the optimization index is the service quality and resources that can be used for communication are not sufficient (cases in which all communication with the communication terminals 3 cannot satisfy the requested service quality defined by the control information). Further, in a case where the acquisition section 111 is configured to calculate the transmission power on the basis of the remaining power and the power consumption, for example, the determination section 112A may be configured to optimize the power consumption by carrying out control for, for example, lowering the transmission power in a case where the remaining power is equal to or less than a predetermined value.

The determination section 112A in accordance with the present example embodiment can omit calculation of the optimization index for the following directivity pattern by referring to the control information. The directivity pattern for which calculation of the optimization index can be omitted includes, for example, a directivity pattern in which the number of beams B to be generated exceeds the maximum number of beams or a directivity pattern in which irradiation is performed with a beam B that requires power exceeding the power consumption. Note that the determination section 112A may be configured to carry out weighting in accordance with an application of communication, in calculation of the system rate in the manner described above. Alternatively, the determination section 112A may be configured to carry out, for example, calculation of the system rate with reference to a database in which information pertaining to reception power in the past is accumulated, instead of calculation of the system rate with use of the above formulae (3) and (4).

### Irradiation Processing Section

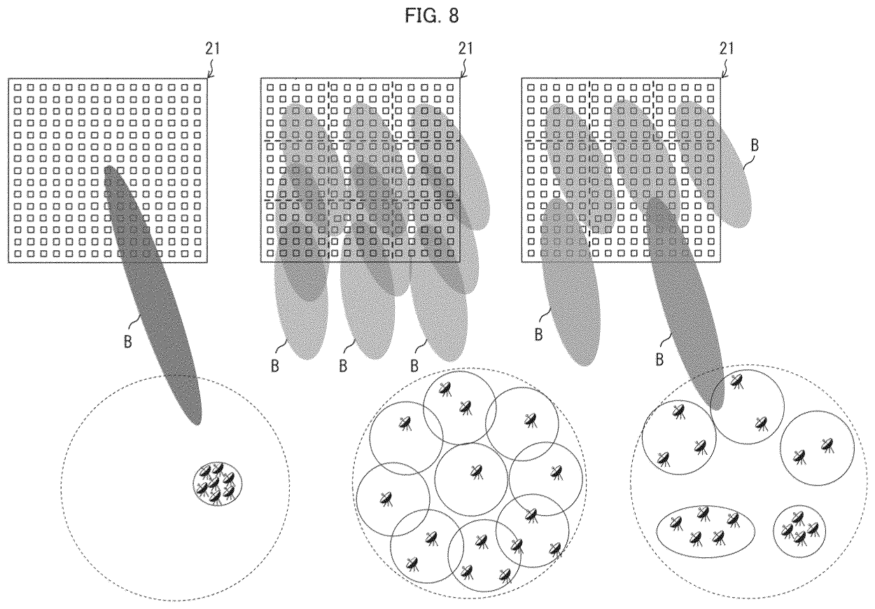

The irradiation processing section 113 controls the antenna 21 (transmits a control signal to the communication apparatus 2) so that the antenna 21 performs irradiation with the beam(s) B in accordance with the directivity pattern and the allocation of the frequency band(s) which have been determined by the determination section 112A. Thus, for example, for a place where a plurality of communication terminals 3 are concentrated in one place (i.e., density of the communication terminals 3 is equal to or more than a predetermined value), as illustrated in a left part of FIG. 8, the antenna 21 performs irradiation with a single beam B (a subarray that emits the single beam B has a high gain). In contrast, for example, for a place where a plurality of communication terminals 3 are dispersed in a wide area (i.e., the density of the communication terminals 3 is less than a predetermined value) or a place where no communication terminal is present, as illustrated in a central part of FIG. 8, the antenna 21 performs irradiation with a plurality of beams B (respective subarrays that emit the plurality of beams each have a low gain). Further, for example, for a place where an area in which a plurality of communication terminals 3 are concentrated and an area in which a plurality of communication terminals 3 are dispersed are mixedly present, as illustrated in a right part of the FIG. 8, the antenna performs irradiation with a plurality of beams B by subarrays which have respective different gains.

In performing irradiation with a plurality of beams B, the antenna 21 performs, for example, for cells C which are apart from each other by equal to or more than a predetermined distance as illustrated in FIG. 7, the irradiation with beams B to which the same frequency band is allocated. In contrast, for the cells C which are apart from each other by less than a predetermined distance or which partially overlap with each other, the antenna 21 performs irradiation with respective beams B to which different frequency bands are allocated.

Moreover, the irradiation processing section 113 controls the antenna 21 so that the antenna 21 changes an irradiation angle of a beam B following a communication terminal 3. Thus, the antenna 21 adjusts the irradiation angle of the beam B so that the communication terminal 3 continues to be present in a cell C, for example, in a case where a mobile communication terminal 3 moves.

### (Example Advantage of Communication Control Apparatus)

The communication control apparatus 1A described above, similarly to the communication control apparatus 1 in accordance with the first example embodiment, yields an example advantage of making it possible to improve utilization efficiency of frequency bands in communication using beams B. Moreover, the communication control apparatus 1A described above employs a configuration in which an optimization index is calculated, on the basis of control information, for each of all combinations of allocation of the frequency band(s) and directivity patterns of an antenna. Moreover, the communication control apparatus 1A employs a configuration that employs a directivity pattern of the antenna and allocation of the frequency band(s) with which the optimization index is most improved. Therefore, the communication control apparatus 1A can yield an example advantage of being capable of determining a directivity pattern of the antenna and allocation of the frequency band(s) which are most efficient.

### Third Example Embodiment

The following description will discuss a third example embodiment, which is an example embodiment of the present invention, in detail with reference to the drawings. Members having functions identical to those of the respective members discussed in the foregoing example embodiments are given respective identical reference numerals, and the description of those members is omitted as appropriate. It should be noted that the applicable scope of each technical means employed in the present example embodiment is not limited to the present example embodiment. That is, each technical means employed in the present example embodiment can be employed also in another example embodiment included in the present disclosure, provided that no particular technical problems occur. Further, each technical means illustrated in the drawings which are referred to for describing the present example embodiment can be employed in another example embodiment included in the present disclosure, provided that no particular technical problems occur.

### (Configuration of Communication Control Apparatus)

The following description will discuss a configuration of a communication control apparatus 1B, with reference to FIG. 6. FIG. 6 is a block diagram illustrating the configuration of the communication control apparatus 1B. The communication control apparatus 1B in accordance with the present example embodiment differs from the communication control apparatus 1A in accordance with the second example embodiment in determination method for a directivity pattern and allocation of a frequency band(s). The communication control apparatus 1B includes a control section 11B. The control section 11B includes a determination section 112B, in addition to an acquisition section 111A and an irradiation processing section 113 which are the same as those included in the communication control apparatus 1A.

### Determination Section

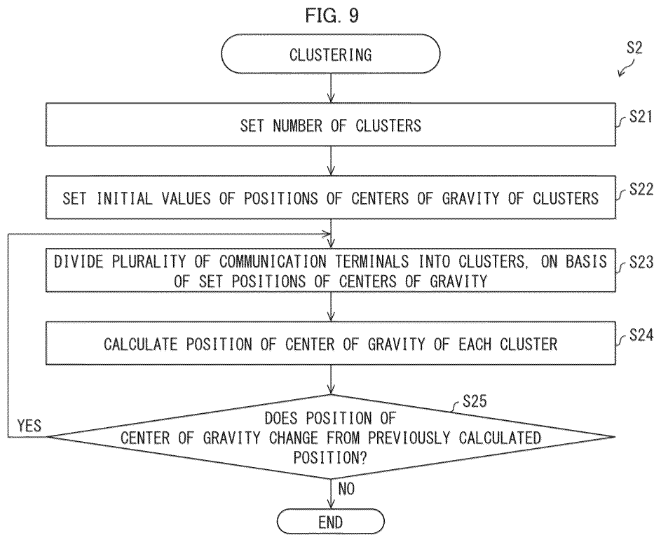

The determination section 112B in accordance with the present example embodiment carries out clustering of a plurality of communication terminals 3 on the basis of the control information acquired by the acquisition section 111. The determination section 112B in accordance with the present example embodiment carries out, with use of the k-means method, a clustering process S2, for example, through a flow as illustrated in FIG. 9.

In a number-of-clusters setting process S21 which is carried out first, the determination section 112B sets the number of clusters. The determination section 112B in accordance with the present example embodiment sets, as the number of clusters, the maximum number of beams (control information) acquired by the acquisition section 111. Note that, in a case where it is not necessary to consider a remaining power of the communication apparatus 2, the determination section 112B may be configured to set, as the number of clusters, the number of unit configurations 21a of the antenna 21.

After the number of clusters is determined, the process proceeds to an initial value setting process S22. In the initial value setting process S22, the determination section 112B sets respective initial values of positions (coordinates) of centers of gravity of clusters such that the number of initial values correspond to the number of clusters which have been set. The initial values of the clusters can be arbitrarily set (but set not to be identical to each other). However, it is preferable to set, in consideration of respective widths of beams B with which the clusters are to be irradiated, the initial values so that the centers of gravity are apart from each other by at least a distance equal to widths of the beams B.

After the initial values of the centers of gravity are set, the process proceeds to a dividing process S23. In the dividing process S23, the determination section 112B divides the plurality of communication terminals 3 into the clusters on the basis of the positions of the centers of gravity set above. Specifically, the determination section 112B calculates the distance between a communication terminal 3 and each of the centers of gravity, and causes the communication terminal 3 to belong to a cluster whose center of gravity is at the smallest distance from the communication terminal 3. This is carried out for each of the plurality of communication terminals 3.

After each of all of the communication terminals 3 is caused to belong to one of the clusters, the process proceeds to a center-of-gravity calculation process S24. In the center-of-gravity calculation process S24, the determination section 112B calculates the position of the center of gravity of each of the clusters.

Thereafter, the dividing process S23 and the center-of-gravity calculation process S24 are repeated until it is determined that the positions of the centers of gravity are unchanged from those calculated in a preceding center-of-gravity calculation process S24 (determination process S25: NO). The wording “unchanged” may mean that difference in positions of the centers of gravity before and after the dividing process S23 is zero, or may mean that the difference in positions is equal to or less than a predetermined value. The clustering by the k-means method is carried out through the flow described above. Then, the determination section 112B determines the number of clusters obtained above, as the number of beams B with which the communication apparatus 2 performs irradiation. At this time, the determination section 112B determines, as irradiation directions of the beams B, respective directions in which the centers of gravity of the clusters obtained above are located. Moreover, the determination section 112B determines a shape of each of the beams B in accordance with a distribution of the communication terminals 3 in a corresponding one of the clusters.

Further, the determination section 112B determines allocation of a frequency band to each of the beams B on the basis of a positional relation of a plurality of cells C which are to be formed by the beams B with which irradiation toward respective centers of gravity of the clusters is to be performed. The determination method is similar to that used by the communication control apparatus 1A in accordance with the second example embodiment.

Note that the determination section 112B may be configured to carry out clustering in a plurality of patterns which have respective different conditions. The “conditions” include, for example, the number of clusters and the initial values of the positions of the centers of gravity of the clusters. The initial values of the positions of the centers of gravity may be changed without changing the width of the beams B (distance between the centers of gravity of the clusters), or may be changed after changing the width of the beams B. In such a configuration, the determination section 112B determines allocation of a frequency band(s) every time clustering is carried out under different conditions. Note that the determination section 112B may carry out, simultaneously and in parallel, clustering in at least some of the plurality of patterns which have different conditions. Moreover, in this case, the determination section 112B calculates an optimization index for each combination of a directivity pattern of the antenna 21 and allocation of a frequency band(s) for the time at which irradiation toward the centers of gravity of the clusters is performed with respective beams B. The content, a calculation method, and the like of the optimization index to be calculated are the same as those employed by the communication control apparatus 1A in accordance with the second example embodiment.

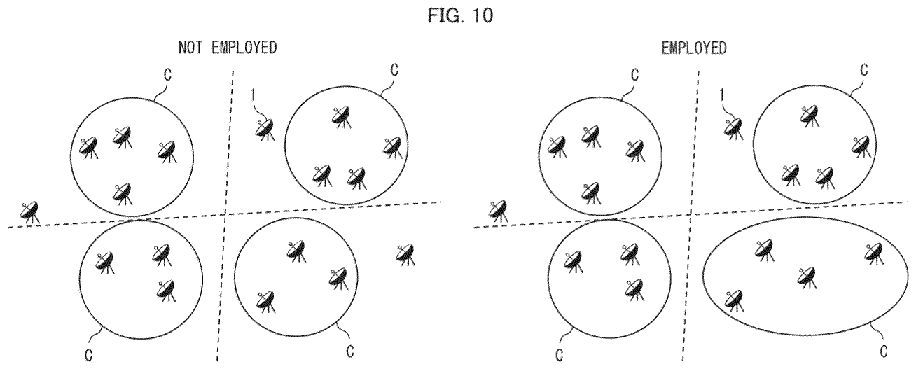

Then, the determination section 112B selects a set that improves an optimization index to the largest degree, from among a plurality of sets (each of which is a set of a candidate of the number of the beams B (the number is one or more), a candidate of a shape of each of the beams B, a candidate of an angle of irradiation with each of the beams B, and a candidate of gain of the antenna 21) which are determined on the basis of results of the clustering in the plurality of patterns. Then, the determination section 112B determines the set thus selected, as the number of the beams B with which the communication apparatus 2 performs irradiation, the shape of each of the beams B, the angle of irradiation with each of the beams B, and the gain of the antenna 21. Specifically, it is assumed that, for example, a clustering result (an example of a case in which all of cells C are circular) illustrated in a left part of FIG. 10 and a clustering result (an example of a case in which one or some of the cells C are elliptical) illustrated in a right part of FIG. 10 are obtained for distribution of a plurality of communication terminals 3. In this case, in the result illustrated in the right part of FIG. 10, the number of communication terminals 3 that are not accommodated in the cells C is smaller and the optimization index is higher. Therefore, the determination section 112B employs the clustering result illustrated in the right part of FIG. 10.

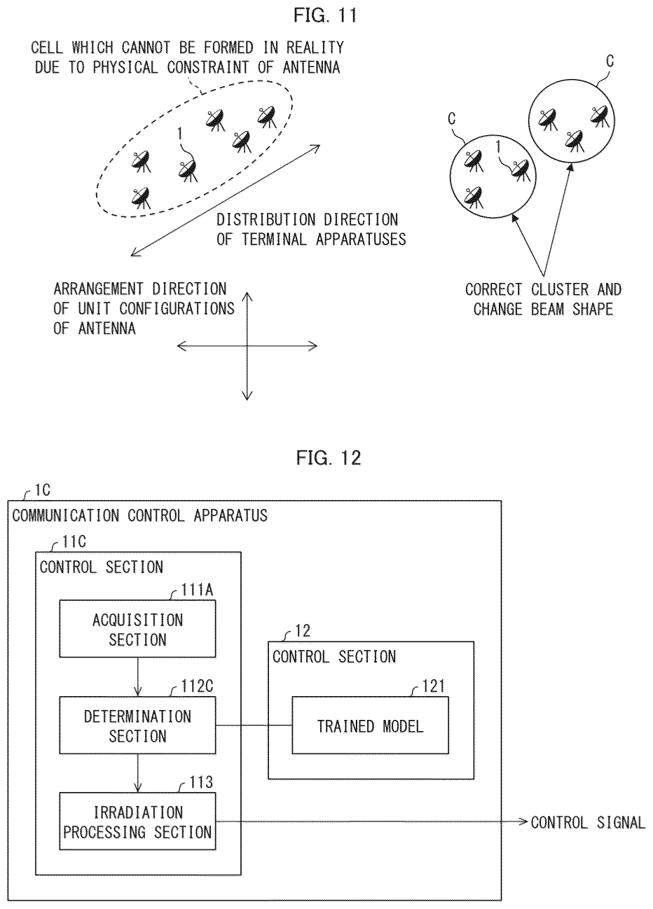

Note that the determination section 112B in accordance with the present example embodiment corrects a cluster or a beam with which the cluster is irradiated, in the following cases. Examples of the case in which a beam is corrected include a case in which the shape of a beam determined in accordance with a distribution of the communication terminals 3 in a cluster cannot be generated under a physical constraint of the antenna 21 which is defined by the constraint information. For example, in a case where a cluster in which a plurality of communication terminals 3 are distributed in an obliquely long area is formed as illustrated in a left part FIG. 11, forming an elliptical cell C that obliquely extends as indicated by dotted line in FIG. 11 makes it possible to accommodate, in the cell C, the plurality of communication terminals 3 included in the cluster. However, in the case of the antenna 21 in which an array of unit configurations 21a is in the form of a matrix as illustrated in FIG. 3, the antenna 21 is physically constrained such that the elliptical cell C can only be formed so as to be long in a direction in which the unit configurations 21a are aligned. Therefore, in a case where the communication terminals 3 are not distributed in a direction parallel to the direction in which the unit configurations 21a are aligned, the antenna 21 forms an elliptical cell C that is long in the lateral direction or the vertical direction in FIG. 11. As a result, some of the communication terminals 3 cannot be accommodated in the cell C. In this case, for example, the determination section 112B carries out correction in which the cluster is divided into a plurality of clusters as illustrated in a right part of FIG. 11. This allows a resultant plurality of divided clusters to be irradiated with beams B that each have a circular cross-section. Note that the determination section 112B may correct the beam B with which the cluster is to be irradiated so that a large circular cell C that can accommodate the cluster illustrated in the left part of FIG. 11 can be formed.

### (Example Advantage of Communication Control Apparatus)

The communication control apparatus 1B described above, similarly to the communication control apparatus 1 in accordance with the first example embodiment, yields an example advantage of making it possible to improve utilization efficiency of frequency bands in communication using beams B. Moreover, the communication control apparatus 1B described above employs a configuration in which the directivity pattern of an antenna and allocation of a frequency band(s) are determined through clustering. Therefore, the communication control apparatus 1B yields an example advantage of making it possible to determine the directivity pattern of antenna and the allocation of a frequency band(s) with use of a smaller amount of calculation and a shorter time for the calculation than the communication control apparatus 1A in accordance with the second example embodiment.

### Fourth Example Embodiment

The following description will discuss a fourth example embodiment, which is an example embodiment of the present invention, in detail with reference to the drawings. Members having functions identical to those of the respective members discussed in the foregoing example embodiments are given respective identical reference numerals, and the description of those members is omitted as appropriate. It should be noted that the applicable scope of each technical means employed in the present example embodiment is not limited to the present example embodiment. That is, each technical means employed in the present example embodiment can be employed also in another example embodiment included in the present disclosure, provided that no particular technical problems occur. Further, each technical means illustrated in the drawings which are referred to for describing the present example embodiment can be employed in another example embodiment included in the present disclosure, provided that no particular technical problems occur.

### (Configuration of Communication Control Apparatus)

The following description will discuss a configuration of a communication control apparatus 1C, with reference to FIG. 12. FIG. 12 is a block diagram illustrating the configuration of the communication control apparatus 1C. The communication control apparatus 1C in accordance with the present example embodiment differs from the communication control apparatus 1A in accordance with the second example embodiment in determination method for a directivity pattern and allocation of a frequency band(s). The communication control apparatus 1C includes a control section 11C and a storage section 12. The control section 11C includes a determination section 112C, in addition to an acquisition section 111A and an irradiation processing section 113 which are the same as those included in the communication control apparatus 1A.

### Storage Section

The storage section 12 stores a trained model 121. The storage section 12 in accordance with the present example embodiment includes a semiconductor memory, a hard disk drive, and the like.

The trained model 121 is a model that is constructed by machine learning using, as training data, a set of past control information acquired in the past, and a directivity pattern of an antenna 21 in a communication apparatus 2 and allocation of a frequency band(s) at a time point at which the past control information was acquired. The trained model 121 in accordance with the present example embodiment is a result of causing a convolutional neural network (CNN) to carry out machine learning with a data set consisting of a large amount of training data. The training data can be acquired, for example, by full search carried out by the communication control apparatus 1A in accordance with the second example embodiment above or by clustering carried out by the communication control apparatus 1B in accordance with the third example embodiment above.

### Determination Section

The determination section 112C inputs, to the trained model 121, the control information acquired by the acquisition section 111. Then, the determination section 112C determines, as the directivity pattern of the antenna 21 and the allocation of the frequency band(s), respective prediction values that are outputted from the trained model 121.

### (Example Advantage of Communication Control Apparatus)

The communication control apparatus 1C described above, similarly to the communication control apparatus 1 in accordance with the first example embodiment, can yield an example advantage of making it possible to improve utilization efficiency of frequency bands in communication using beams B. Moreover, the communication control apparatus 1C described above employs a configuration in which the directivity pattern of an antenna and allocation of a frequency band(s) are determined with use of the trained model 121. Therefore, the communication control apparatus 1C can yield an example advantage of making it possible to determine the directivity pattern of an antenna and allocation of a frequency band(s) with use of a smaller amount of calculation and a shorter time for the calculation than the communication control apparatus 1A in accordance with the second example embodiment.

### Fifth Example Embodiment

The following description will discuss a fifth example embodiment, which is an example embodiment of the present invention, in detail with reference to the drawings. Members having functions identical to those of the respective members discussed in the foregoing example embodiments are given respective identical reference numerals, and the description of those members is omitted as appropriate. It should be noted that the applicable scope of each technical means employed in the present example embodiment is not limited to the present example embodiment. That is, each technical means employed in the present example embodiment can be employed also in another example embodiment included in the present disclosure, provided that no particular technical problems occur. Further, each technical means illustrated in the drawings which are referred to for describing the present example embodiment can be employed in another example embodiment included in the present disclosure, provided that no particular technical problems occur.

### (Configuration of Communication System)

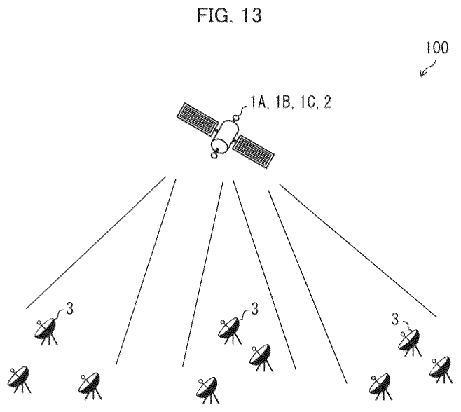

The following description will discuss a configuration of a communication system 100, with reference to FIG. 13. FIG. 13 is a block diagram illustrating the configuration of the communication system 100. The communication system 100 in accordance with the present example embodiment includes: one selected from the group consisting of the communication control apparatuses 1, 1A, 1B, and 1C in accordance with the first to fourth example embodiments; a communication apparatus 2; and a plurality of communication terminals 3. Note that although FIG. 13 illustrates, as an example, a case of the communication system 100 in which the communication control apparatus 1 is mounted on the communication apparatus 2, the communication control apparatus 1 may be mounted on ground equipment (e.g., a central unit (CU) or the like) or may be independent of the communication apparatus 2 and the ground equipment.

### Communication Terminal

The plurality of communication terminals 3 carry out wireless communication with the communication apparatus 2. Note that the communication terminals 3 may include an antenna capable of giving directivity to a radio wave so that the communication terminal 3 can follow the communication apparatus 2.

### Artificial Satellite

The communication apparatus 2 carries out wireless communication with a plurality of communication terminals 3. The communication apparatus 2 in accordance with the present example embodiment is an artificial satellite which travels in an orbit. The orbit in which the communication apparatus 2 travels is not particularly limited, and may be a low-altitude orbit, a medium-altitude orbit, or a geostationary orbit. The communication apparatus 2 includes an antenna 21. Thus, the communication apparatus 2 can communicate with the plurality of communication terminals 3 by irradiating the plurality of communication terminals 3 with a radio wave beam(s) B from the antenna 21. Note that the communication apparatus 2 is not limited to an artificial satellite. The communication apparatus 2 may be, for example, a wireless base station installed on the ground, an aircraft (e.g., a spacecraft) constituting a high altitude platform station (HAPS), or the like.

### (Example Advantage of Communication System)

The communication system 100 described above employs a configuration including one selected from the group consisting of the communication control apparatuses 1, 1A, 1B, and 1C in accordance with the first to fourth example embodiments. That is, frequency bands allocated to respective beams B correspond to the number, distribution, and the like of the communication terminals 3. Therefore, the communication system 100 in accordance with the present example embodiment can yield an example advantage of making it possible to improve utilization efficiency of frequency bands in communication using the beams B.

### (Flow 1 of Communication Control Method)

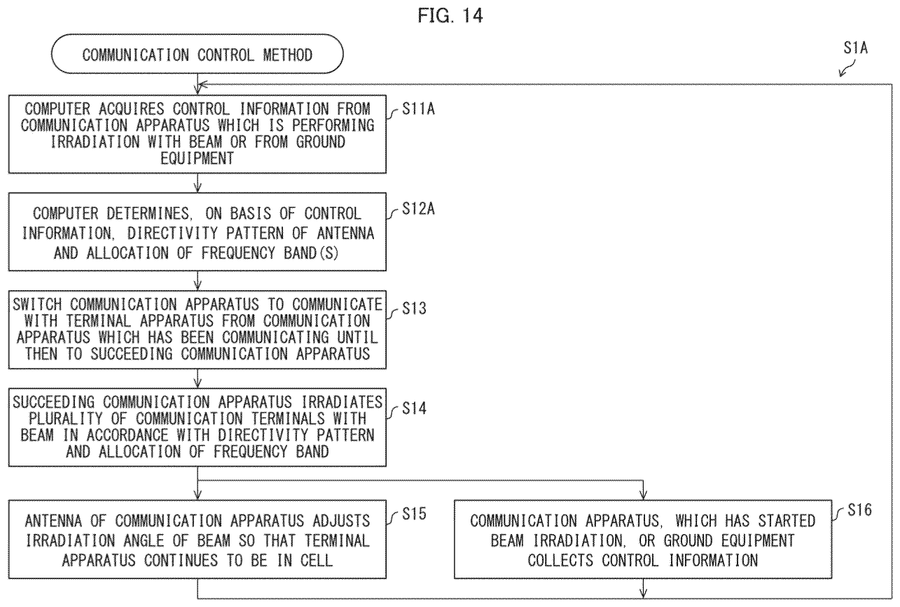

The following description will discuss a flow of a communication control method S1A, with reference to FIG. 14. FIG. 14 is a flowchart illustrating the flow of the communication control method S1A. The communication control method S1A is a method of controlling the communication apparatus 2. The communication apparatus 2 to be controlled in the present example embodiment is an artificial satellite. The communication control method S1A in accordance with the present example embodiment is used in a case where a plurality of artificial satellites are traveling in one orbit. The communication control method S1A includes an acquisition process S11A, a determination process S12A, a switching process S13, an irradiation process S14, a follow-up process S15, and a collection process S16, as illustrated in FIG. 14.

### Acquisition Process

In the acquisition process S11A which is carried out first, a computer acquires control information. The computer may constitute the communication control apparatus 1, 1A, 1B, or 1C. Alternatively, the computer may be mounted on each communication apparatus 2 or may be mounted on ground equipment (CU, etc.). The computer acquires the control information from the communication apparatus 2 (which is communicating with communication terminals 3) which is irradiating the communication terminals 3 with a beam B. The control information includes terminal position information, apparatus position information, and constraint information, similarly to that acquired by the communication control apparatuses 1, 1A, 1B, and 1C.

### Determination Process

After the control information is acquired, the process proceeds to the determination process S12A. In the determination process S12A, the computer determines, on the basis of the control information, a directivity pattern of the antenna 21 in generation of a beam B and allocation of a frequency band to the beam B. The computer determines, on the basis of the control information acquired from the communication apparatus 2 that is communicating, a directivity pattern for the time at which a succeeding communication apparatus 2 (to which communication is handed over) performs irradiation with the beam B, and allocation of a frequency band to the beam B. Such determination of the directivity pattern and the allocation of the frequency band can be carried out by a method that is the same as the method carried out by the communication control apparatus 1, 1A, 1B, or 1C.

### Switching Process

After the directivity pattern and the allocation of the frequency band are determined, the process proceeds to the switching process S13. In the switching process S13, the communication apparatus 2 which communicates with the plurality of communication terminals 3 is switched from the communication apparatus 2 which was communicating with the communication terminals 3 until then to the succeeding communication apparatus 2 (handover).

### Irradiation Process

After the communication apparatus 2 communicating with the communication terminals 3 is switched, the process proceeds to the irradiation process S14. In the irradiation process S14, the communication apparatus 2 after switching irradiates the plurality of communication terminals 3 with a beam B that is a radio wave in accordance with the directivity pattern and the allocation of the frequency band which have been determined by the computer. Thus, the communication apparatus 2 can communicate with the communication terminals 3.

### Follow-Up Process

After the communication terminals 3 are irradiated with the beam B, the process proceeds to the follow-up process S15. In the follow-up process S15, in a case where the communication terminals 3 which are movable moves or the like, the antenna 21 of the communication apparatus 2 adjusts an irradiation angle of the beam B so that the communication terminals 3 continue to be present in a cell C.

### Collection Process

In parallel with causing the beam B to follow the communication terminals 3, the collection process S16 is carried out. In the collection process S16, the communication apparatus 2 which is performing irradiation with the beam B, or ground equipment collects control information. This control information is sent to the communication control apparatus 1 by the communication apparatus 2 which is performing irradiation with the beam B (the acquisition process S11 is repeated). Then, the control information is used for determining the directivity pattern for the time at which the succeeding communication apparatus 2 (to which the communication is handed over next) performs irradiation with the beam B and the allocation of the frequency band to the beam B.

### (Example Advantage of Communication Control Method)

The communication control method described above, similarly to the communication control method in accordance with the first example embodiment, can yield an example advantage of making it possible to improve utilization efficiency of frequency bands in communication using beams B. Further, the communication control method described above employs a configuration in which the directivity pattern for the time at which the succeeding communication apparatus 2 performs irradiation with the beam B and the allocation of the frequency band to the beam B are determined with use of the control information which has been acquired from the communication apparatus 2 that is currently communicating. Therefore, the communication control method yields an example advantage of making it possible to smoothly switch the communication apparatus 2 since, in a case where the communication apparatus 2 is to be switched, the directivity pattern and the allocation of the frequency band are determined.

### (Flow 2 of Communication Control Method)

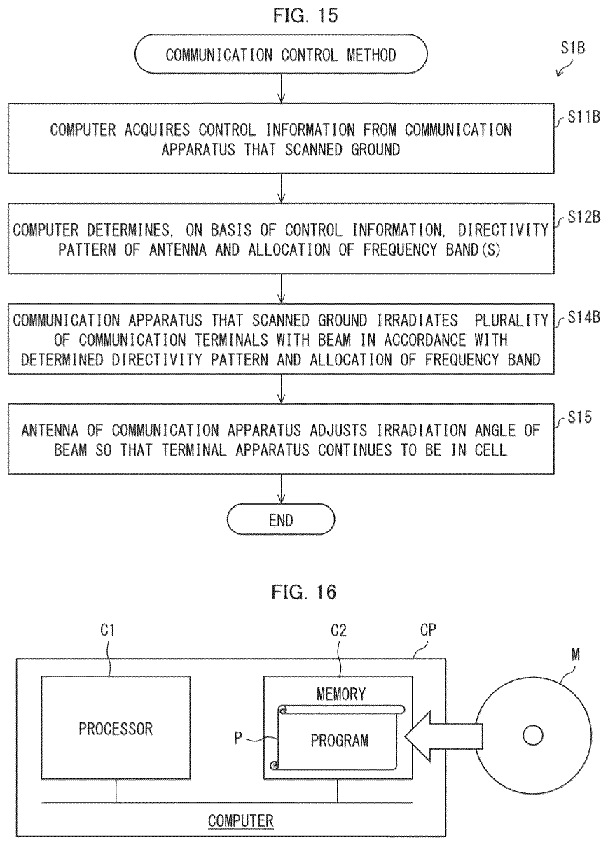

The following description will discuss a flow of a communication control method S1B, with reference to FIG. 15. FIG. 15 is a flowchart illustrating the flow of the communication control method S1B. The communication control method S1B is a method in which the communication apparatus 2 communicates with communication terminals 3 with use of the communication control apparatus 1, 1A, 1B, or 1C. The communication apparatus 2 to be controlled in the present example embodiment is an artificial satellite that can scan the ground to obtain position information indicating a position of the communication apparatus 2 itself. As illustrated in FIG. 15, the communication control method S1B includes an acquisition process S11B, a determination process S12B, and an irradiation process S14B, in addition to the follow-up process S15 which is similar to that included in the communication control method S1A according to the flow 2 of the communication control method.

### (Acquisition Process)

In the first acquisition process S11B, a computer acquires control information. The computer may constitute the communication control apparatus 1, 1A, 1B, or 1C. The computer acquires, from the communication apparatus 2 (which is communicating with the communication terminals 3) which is irradiating the communication terminals 3 with the beam B, control information which the communication apparatus 2 has obtained by repeatedly scanning the ground. The computer acquires the control information every time the communication apparatus 2 carries out scanning. The control information includes terminal position information, apparatus position information, and constraint information, similarly to that acquired by the communication control apparatuses 1, 1A, 1B, and 1C.

### (Determination Process)

After the control information is acquired, the process proceeds to the determination process S12B. In the determination process S12B, the computer determines, on the basis of the control information, a directivity pattern of the antenna 21 in generation of a beam B and allocation of a frequency band to the beam B. The computer determines the directivity pattern for the time at which the communication apparatus 2 (which has sent the control information to the computer) which has carried out the scanning performs irradiation with the beam B and allocation of the frequency band to the beam B. The computer determines the directivity pattern and the allocation of the frequency band every time the control information is acquired (every time the communication apparatus 2 carries out the scanning). Such determination of the directivity pattern and the allocation of the frequency band can be carried out by a method that is the same as the method carried out by the communication control apparatus 1, 1A, 1B, or 1C.

After the directivity pattern and the allocation of the frequency band are determined, the process proceeds to then irradiation process S14B. In the irradiation process S14B, the communication apparatus 2 irradiates the plurality of communication terminals 3 with the beam B that is a radio wave in accordance with the directivity pattern and the allocation of the frequency band which have been determined by the computer. Every time the directivity pattern and the allocation of the frequency band are determined (every time the communication apparatus 2 carries out scanning), the computer changes the beam B with which irradiation is performed to a beam that corresponds to the directivity pattern and the allocation of the frequency band.

### (Example Advantage of Communication Control Method)

The communication control method described above, similarly to the communication control method in accordance with the first example embodiment, can yield an example advantage of making it possible to improve utilization efficiency of frequency bands in communication using beams B. Further, the communication control method described above employs a configuration in which the directivity pattern for the time at which the communication apparatus 2 performs irradiation with the beam B and the allocation of the frequency band to the beam B are determined by using the control information which the communication apparatus 2 has acquired by scanning the ground. Therefore, the communication control method can yield an example advantage of making it possible to deal with a case in which there is only one communication apparatus 2 or a case in which no communication with another communication apparatus 2 is carried out. Furthermore, the communication control method can yield an example advantage of making it possible to immediately communicate with a communication terminal 3 even in a case where while the communication apparatus 2 is performing irradiation with a beam B, the communication terminal 3 is newly turned on.

### Software Implementation Example

The functions of all or part of each of the communication control apparatuses 1, 1A, 1B, and 1C (hereinafter also referred to as “the each apparatus”) can be realized by hardware such as an integrated circuit (IC chip) or can be alternatively realized by software.

In the latter case, the each apparatus is realized by, for example, a computer that executes instructions of a program that is software realizing the foregoing functions. FIG. 16 illustrates an example of such a computer (hereinafter referred to as “computer CP”). FIG. 16 is a block diagram illustrating a hardware configuration of the computer CP which functions as the each apparatus.

The computer CP includes at least one processor C1 and at least one memory C2. The memory C2 stores a program P for causing the computer CP to function as the each apparatus. In the computer CP, the processor C1 reads the program P from the memory C2 and executes the program P, so that the functions of the each apparatus are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. The memory C2 can be, for example, a flash memory, a hard disk drive (HDD), a solid state drive (SSD), or a combination of these.

Note that the computer CP may further include a random access memory (RAM) into which the program P is loaded at the time of execution and in which various kinds of data are temporarily stored. The computer CP can further include a communication interface for carrying out transmission and reception of data to/from another apparatus. The computer CP may further include an input/output interface through which an input/output apparatus(es) such as a keyboard, a mouse, a display and/or a printer is/are to be connected to the computer CP.

The program P can be stored in a non-transitory tangible storage medium M that can be read by the computer CP. Examples of the storage medium M encompass a tape, a disk, a card, a semiconductor memory, and a programmable logic circuit. The computer CP can obtain the program P via such a storage medium M. Further, the program P can be transmitted via a transmission medium. Examples of such a transmission medium encompass a communication network or a broadcast wave. The computer CP can also acquire the program P via the transmission medium.

### Additional Remark 1

The present disclosure includes techniques discussed in supplementary notes below. Note, however, that the present invention is not limited to the techniques discussed in supplementary notes below, but may be altered in various ways by a skilled person within the scope of the claims.

### Supplementary Note 1

A communication control apparatus including a control section which controls a communication apparatus,
the communication apparatus being capable of communicating with a plurality of communication terminals by irradiating the plurality of communication terminals with a radio wave beam from an antenna,
the control section including:
   an acquisition section which acquires control information that includes
   terminal position information indicating positions of the plurality of communication terminals,
   apparatus position information indicating a position of the communication apparatus, and
   constraint information including information indicating a physical constraint of the antenna; and
a determination section which determines, on the basis of the control information,
   a directivity pattern of the antenna in generation of the beam, and
   allocation of a frequency band to the beam.

### Supplementary Note 2

The communication control apparatus according to supplementary note 1, wherein the determination section determines, on the basis of a positional relation of a plurality of cells which are to be formed by a plurality of the beams, the allocation of the frequency band to each of the beams.

### Supplementary Note 3

The communication control apparatus according to supplementary note 1 or 2, wherein:
the determination section carries out clustering of the plurality of communication terminals on the basis of the control information;
the determination section determines, as the number of the beams with which irradiation is performed by the communication apparatus, the number of clusters obtained; and
the determination section determines respective shapes of the beams in accordance with distribution of the communication terminals in each of the clusters.

### Supplementary Note 4

The communication control apparatus according to supplementary note 3, wherein:
the determination section carries out the clustering in a plurality of patterns having respective different conditions; and
the determination section selects a set that improves an optimization index to the largest degree, from among a plurality of sets which are determined on the basis of results of the clustering in the plurality of patterns and each of which is a set of a candidate of the number of the beams, a candidate of a shape of each of the beams, a candidate of an angle of irradiation with each of the beams, and a candidate of a gain of the antenna, and determines, as the number of the beams with which irradiation is performed by the communication apparatus, the shapes of the beams, the angles of emission of the beams, and the gain of the antenna, candidates in the set which has been selected.

### Supplementary Note 5

The communication control apparatus according to supplementary note 4, wherein the optimization index includes one or both of:
a system rate that is a total of communication path capacities which the communication terminals are in need of; and
service quality in accordance with an application of communication carried out by each of the plurality of communication terminals.

### Supplementary Note 6

The communication control apparatus according to supplementary note 4 or 5, wherein the determination section corrects the clusters or the beams with which the clusters are irradiated, in a case where the shapes of the beams determined in accordance with the distribution of the communication terminals in the clusters is not generable under a physical constraint of the antenna which is defined by the constraint information.

### Supplementary Note 7

The communication control apparatus according to any one of supplementary notes 1 to 6, wherein the control information further includes at least one selected from the group consisting of:
the maximum number of beams which is an upper limit of the number of beams that are generable; and
a power consumption required for generating the beams.

### Supplementary Note 8

The communication control apparatus according to supplementary note 7, wherein:
the acquisition section acquires remaining power that is a remaining amount of electric power which a battery provided in the communication apparatus is capable of supplying; and
the acquisition section calculates, on the basis of the remaining power, at least one selected from the group consisting of the maximum number of beams and the power consumption.

### Supplementary Note 9

The communication control apparatus according to any one of supplementary notes 1 to 8, wherein:
the determination section inputs the control information to a trained model constructed by machine learning using, as training data, a set of
   past control information acquired in the past, and
   a directivity pattern of the antenna in the communication apparatus and the allocation of the frequency band at a time point at which the past control information was acquired; and
the determination section determines, as the directivity pattern of the antenna and the allocation of the frequency band, respective prediction values outputted from the trained model.

### Supplementary Note 10

A communication system including:
a plurality of communication terminals;
an artificial satellite that travels in an orbit and that is a communication apparatus which communicates with the plurality of communication terminals; and
the communication control apparatus according to any one of supplementary notes 1 to 9.

### Supplementary Note 11

A communication control program for causing a computer to function as the communication control apparatus according to any one of supplementary notes 1 to 9, the communication control program causing the computer to function as the foregoing acquisition section and the foregoing determination section.

### Supplementary Note 12

A communication control method for controlling a communication apparatus,
the communication apparatus being capable of communicating with a plurality of communication terminals by irradiating the plurality of communication terminals with a radio wave beam from an antenna,
the communication control method including:
an acquisition process in which a computer acquires control information that includes
   terminal position information indicating positions of the plurality of communication terminals,
   apparatus position information indicating a position of the communication apparatus, and
   constraint information including information indicating a physical constraint of the antenna; and
a determination process in which the computer determines, on the basis of the control information,
   a directivity pattern of the antenna in generation of the beam, and
   allocation of a frequency band to the beam.

### Supplementary Note 13

The communication control method according to supplementary note 12, wherein in the determination process, the allocation of the frequency band to each of the beams is determined on the basis of a positional relation of a plurality of cells which are to be formed by a plurality of the beams.

### Supplementary Note 14

The communication control method according to supplementary note 12 or 13, wherein in the determination process:
clustering of the plurality of communication terminals is carried out on the basis of the control information;
the number of clusters obtained is determined as the number of the beams with which irradiation is performed by the communication apparatus; and
respective shapes of the beams are determined in accordance with distribution of the communication terminals in each of the clusters.

### Supplementary Note 15

The communication control method according to supplementary note 14, wherein in the determination process:
the clustering in a plurality of patterns having respective different conditions is carried out; and
a set that improves an optimization index to the largest degree is selected from among a plurality of sets which are determined on the basis of results of the clustering in the plurality of patterns and each of which is a set of a candidate of the number of the beams, a candidate of a shape of each of the beams, a candidate of an angle of irradiation with each of the beams, and a candidate of gain of the antenna, and candidates in the set which has been selected are determined as the number of the beams with which irradiation is performed by the communication apparatus, the shapes of the beams, the angles of emission of the beams, and the gain of the antenna.

### Supplementary Note 16

The communication control method according to supplementary note 15, wherein the optimization index includes one or both of:
a system rate that is a total of communication path capacities which the communication terminals are in need of; and
service quality in accordance with an application of communication carried out by each of the plurality of communication terminals.

### Supplementary Note 17

The communication control method according to supplementary note 15 or 16, wherein in the determination process, the clusters or the beams with which the clusters are irradiated are corrected, in a case where there exists, among the clusters of the communication apparatuses obtained by clustering, a cluster in which one or some of the communication terminals are not accommodated in cells formed by beams which the antenna is capable of emitting.

### Supplementary Note 18

The communication control method according to any one of supplementary notes 12 to 17, wherein the control information further includes at least one selected from the group consisting of:
the maximum number of beams which is an upper limit of the number of beams that are generable; and
a power consumption required for generating the beams.

### Supplementary Note 19

The communication control method according to supplementary note 18, wherein in the acquisition process:
remaining power is acquired, the remaining power being a remaining amount of electric power which a battery provided in the communication apparatus is capable of supplying; and
at least one selected from the group consisting of the maximum number of beams and the power consumption is calculated on the basis of the remaining power.

### Supplementary Note 20

The communication control method according to any one of supplementary notes 12 to 19, wherein in the determination process:
the control information is inputted to a trained model constructed by machine learning using, as training data, a set of
   past control information acquired in the past, and
   a directivity pattern of the antenna in the communication apparatus and the allocation of the frequency band at a time point at which the past control information was acquired; and
respective prediction values outputted from the trained model are determined, as the directivity pattern of the antenna and the allocation of the frequency band.

### Additional Remark 2

The present disclosure includes techniques discussed in supplementary notes below. Note, however, that the present invention is not limited to the techniques discussed in supplementary notes below, but may be altered in various ways by a skilled person within the scope of the claims.

### Supplementary Note 1

A communication control apparatus including at least one processor,
the at least one processor carrying out:
a control process of controlling a communication apparatus capable of communicating with a plurality of communication terminals by irradiating the plurality of communication terminals with a radio wave beam from an antenna;
an acquisition process of acquiring control information that includes
   terminal position information indicating positions of the plurality of communication terminals,
   apparatus position information indicating a position of the communication apparatus, and
   constraint information including information indicating a physical constraint of the antenna; and
a determination process of determining, on the basis of the control information,
   a directivity pattern of the antenna in generation of the beam, and
   allocation of a frequency band to the beam.

Note that the communication control apparatus may further include a memory. Further, the memory may store a program for causing the at least one processor to carry out each of the foregoing processes.

### Supplementary Note 2

The communication control apparatus according to supplementary note 1, wherein
in the determination process, the at least one processor determines, on the basis of a positional relation of a plurality of cells which are to be formed by a plurality of the beams, the allocation of the frequency band to each of the beams.

### Supplementary Note 3

The communication control apparatus according to supplementary note 1 or 2, wherein in the determination process:
the at least one processor carries out clustering of the plurality of communication terminals on the basis of the control information;
the at least one processor determines, as the number of the beams with which irradiation is performed by the communication apparatus, the number of clusters obtained; and
the at least one processor determines respective shapes of the beams in accordance with distribution of the communication terminals in each of the clusters.

### Supplementary Note 4

The communication control apparatus according to supplementary note 3, wherein in the determination process:
the at least one processor carries out the clustering in a plurality of patterns having respective different conditions; and
the at least one processor selects a set that improves an optimization index to the largest degree, from among a plurality of sets which are determined on the basis of results of the clustering in the plurality of patterns and each of which is a set of a candidate of the number of the beams, a candidate of a shape of each of the beams, a candidate of an angle of irradiation with each of the beams, and a candidate of a gain of the antenna, and determines, as the number of the beams with which irradiation is performed by the communication apparatus, the shapes of the beams, the angles of emission of the beams, and the gain of the antenna, candidates in the set which has been selected.

### Supplementary Note 5

The communication control apparatus according to supplementary note 4, wherein the optimization index includes one or both of:
a system rate that is a total of communication path capacities which the communication terminals are in need of; and
service quality in accordance with an application of communication carried out by each of the plurality of communication terminals.

### Supplementary Note 6

The communication control apparatus according to supplementary note 4 or 5, wherein in the determination process, the at least one processor corrects the clusters or the beams with which the clusters are irradiated, in a case where the shapes of the beams determined in accordance with the distribution of the communication terminals in the clusters is not generable under a physical constraint of the antenna which is defined by the constraint information.

### Supplementary Note 7

The communication control apparatus according to any one of supplementary notes 1 to 6, wherein the control information further includes at least one selected from the group consisting of:
the maximum number of beams which is an upper limit of the number of beams that are generable; and
a power consumption required for generating the beams.

### Supplementary Note 8

The communication control apparatus according to supplementary note 7, wherein in the acquisition process:
the at least one processor acquires remaining power that is a remaining amount of electric power which a battery provided in the communication apparatus is capable of supplying; and
the at least one processor calculates, on the basis of the remaining power, at least one selected from the group consisting of the maximum number of beams and the power consumption.

### Supplementary Note 9

The communication control apparatus according to any one of supplementary notes 1 to 8, wherein in the determination process:
the at least one processor inputs the control information to a trained model constructed by machine learning using, as training data, a set of
   past control information acquired in the past, and
   a directivity pattern of the antenna in the communication apparatus and the allocation of the frequency band at a time point at which the past control information was acquired; and
the at least one processor determines, as the directivity pattern of the antenna and the allocation of the frequency band, respective prediction values outputted from the trained model.

### REFERENCE SIGNS LIST

100 communication system
1, 1A, 1B, 1C communication control apparatus
11, 11A, 11B, 11C control section
111, 111A acquisition section
112, 112A, 112B, 112C determination section
113 irradiation processing section
12 storage unit
121 trained model
2 communication apparatus
21 antenna
21a unit configuration
211 antenna element
212 BF circuit
213 DA converter
214 AD converter
215 dividing/coupling circuit
21b digital signal processing section
3 communication terminal
B beam
C cell
CP computer
C1 processor
C2 memory

1. A communication control apparatus comprising at least one processor,
the at least one processor carrying out:
a control process of controlling a communication apparatus capable of communicating with a plurality of communication terminals by irradiating the plurality of communication terminals with a radio wave beam from an antenna;
an acquisition process of acquiring control information that includes
terminal position information indicating positions of the plurality of communication terminals,
apparatus position information indicating a position of the communication apparatus, and
constraint information including information indicating a physical constraint of the antenna; and
a determination process of determining, on the basis of the control information,
a directivity pattern of the antenna in generation of the beam, and
allocation of a frequency band to the beam.

2. The communication control apparatus according to claim 1, wherein
in the determination process, the at least one processor determines, on the basis of a positional relation of a plurality of cells which are to be formed by a plurality of the beams, the allocation of the frequency band to each of the beams.

3. The communication control apparatus according to claim 1, wherein in the determination process:
the at least one processor carries out clustering of the plurality of communication terminals on the basis of the control information;
the at least one processor determines, as the number of the beams with which irradiation is performed by the communication apparatus, the number of clusters obtained; and
the at least one processor determines respective shapes of the beams in accordance with distribution of the communication terminals in each of the clusters.

4. The communication control apparatus according to claim 3, wherein in the determination process:
the at least one processor carries out the clustering in a plurality of patterns having respective different conditions; and
the at least one processor selects a set that improves an optimization index to the largest degree, from among a plurality of sets which are determined on the basis of results of the clustering in the plurality of patterns and each of which is a set of a candidate of the number of the beams, a candidate of a shape of each of the beams, a candidate of an angle of irradiation with each of the beams, and a candidate of gain of the antenna, and determines, as the number of the beams with which irradiation is performed by the communication apparatus, the shapes of the beams, the angles of emission of the beams, and the gain of the antenna, candidates in the set which has been selected.

5. The communication control apparatus according to claim 4, wherein the optimization index includes one or both of:
a system rate that is a total of communication path capacities which the communication terminals are in need of; and
service quality in accordance with an application of communication carried out by each of the plurality of communication terminals.

6. The communication control apparatus according to claim 4, wherein in the determination process, the at least one processor corrects the clusters or the beams with which the clusters are irradiated, in a case where the shapes of the beams determined in accordance with the distribution of the communication terminals in the clusters is not generable under a physical constraint of the antenna which is defined by the constraint information.

7. The communication control apparatus according to claim 1, wherein the control information further includes at least one selected from the group consisting of:
the maximum number of beams which is an upper limit of the number of beams that are generable; and
a power consumption required for generating the beams.

8. The communication control apparatus according to claim 7, wherein in the acquisition process:
the at least one processor acquires remaining power that is a remaining amount of electric power which a battery provided in the communication apparatus is capable of supplying; and
the at least one processor calculates, on the basis of the remaining power, at least one selected from the group consisting of the maximum number of beams and the power consumption.

9. The communication control apparatus according to claim 1, wherein in the determination process:
the at least one processor inputs the control information to a trained model constructed by machine learning using, as training data, a set of
past control information acquired in the past, and
a directivity pattern of the antenna in the communication apparatus and the allocation of the frequency band at a time point at which the past control information was acquired; and
the at least one processor determines, as the directivity pattern of the antenna and the allocation of the frequency band, respective prediction values outputted from the trained model.

10. A communication system comprising:
a plurality of communication terminals;
an artificial satellite that travels in an orbit and that is a communication apparatus which communicates with the plurality of communication terminals; and
the communication control apparatus according to claim 1.

11. A non-transitory storage medium storing therein a communication control program for causing at least one processor to carry out:
a control process of controlling a communication apparatus capable of communicating with a plurality of communication terminals by irradiating the plurality of communication terminals with a radio wave beam from an antenna;
an acquisition process of acquiring control information that includes
terminal position information indicating positions of the plurality of communication terminals,
apparatus position information indicating a position of the communication apparatus, and
constraint information including information indicating a physical constraint of the antenna; and
a determination process of determining, on the basis of the control information,
a directivity pattern of the antenna in generation of the beam, and
allocation of a frequency band to the beam.

12. A communication control method for controlling a communication apparatus,
the communication apparatus being capable of communicating with a plurality of communication terminals by irradiating the plurality of communication terminals with a radio wave beam from an antenna,
the communication control method comprising:
an acquisition process in which at least one processor acquires control information that includes
terminal position information indicating positions of the plurality of communication terminals,
apparatus position information indicating a position of the communication apparatus, and
constraint information including information indicating a physical constraint of the antenna; and
a determination process in which the at least one processor determines, on the basis of the control information,
a directivity pattern of the antenna in generation of the beam, and
allocation of a frequency band to the beam.

13. The communication control method according to claim 12, wherein in the determination process, the allocation of the frequency band to each of the beams is determined on the basis of a positional relation of a plurality of cells which are to be formed by a plurality of the beams.

14. The communication control method according to claim 12, wherein in the determination process:
clustering of the plurality of communication terminals is carried out on the basis of the control information;
the number of clusters obtained is determined as the number of the beams with which irradiation is performed by the communication apparatus; and
respective shapes of the beams are determined in accordance with distribution of the communication terminals in each of the clusters.

15. The communication control method according to claim 14, wherein in the determination process:
the clustering in a plurality of patterns having respective different conditions is carried out; and
a set that improves an optimization index to the largest degree is selected from among a plurality of sets which are determined on the basis of results of the clustering in the plurality of patterns and each of which is a set of a candidate of the number of the beams, a candidate of a shape of each of the beams, a candidate of an angle of irradiation with each of the beams, and a candidate of gain of the antenna, and candidates in the set which has been selected are determined as the number of the beams with which irradiation is performed by the communication apparatus, the shapes of the beams, the angles of emission of the beams, and the gain of the antenna.

16. The communication control method according to claim 15, wherein the optimization index includes one or both of:
a system rate that is a total of communication path capacities which the communication terminals are in need of; and
service quality in accordance with an application of communication carried out by each of the plurality of communication terminals.

17. The communication control method according to claim 15, wherein in the determination process, the clusters or the beams with which the clusters are irradiated are corrected, in a case where there exists, among the clusters of the communication apparatuses obtained by clustering, a cluster in which one or some of the communication terminals are not accommodated in cells formed by beams which the antenna is capable of emitting.

18. The communication control method according to claim 12, wherein the control information further includes at least one selected from the group consisting of:
the maximum number of beams which is an upper limit of the number of beams that are generable; and
a power consumption required for generating the beams.

19. The communication control method according to claim 18, wherein in the acquisition process:
remaining power is acquired, the remaining power being a remaining amount of electric power which a battery provided in the communication apparatus is capable of supplying; and
at least one selected from the group consisting of the maximum number of beams and the power consumption is calculated on the basis of the remaining power.

20. The communication control method according to claim 12, wherein in the determination process:
the control information is inputted to a trained model constructed by machine learning using, as training data, a set of
past control information acquired in the past, and
a directivity pattern of the antenna in the communication apparatus and the allocation of the frequency band at a time point at which the past control information was acquired; and
respective prediction values outputted from the trained model are determined, as the directivity pattern of the antenna and the allocation of the frequency band.
